(19) United States
(12) Patent Application Publication
(10) Pub. No.: US 2007/0219296 A1
(43) Pub. Date: Sep. 20, 2007

(54) Aqueous dispersions based on nitro-cellulose-polyurethane particles

(76) Inventors: Rainer Trinks, Dormagen (DE); Thorsten Rische, Unna (DE); Thomas Feller, Solingen (DE); Steffen Hofacker, Odenthal (DE); Harald Blum, Leverkusen (DE); Hans-Ulrich Meier-Westhues, Leverkusen (DE)

Correspondence Address: BAYER MATERIAL SCIENCE LLC, 100 BAYER ROAD, PITTSBURGH, PA, 15205, US

(21) Appl. No.: 11/716,939

(22) Filed: Mar. 12, 2007

(30) Foreign Application Priority Data
Mar. 17, 2006 (DE) 102006012354.9

(51) Int. Cl. C08L 5/00

(52) U.S. Cl. 524/27

(57) ABSTRACT

The invention relates to aqueous dispersions comprising nitrocellulose-polyurethane-polyurea particles, to a process for preparing them and to their use.

### CROSS-REFERENCE TO RELATED APPLICATION

This application claims priority under 35 U.S.C. § 119 (a-d) to German application DE 10200012354.9, filed Mar. 17, 2006.

### FIELD OF THE INVENTION

The invention relates to aqueous dispersions comprising nitrocellulose-polyurethane-polyurea particles, to a process for preparing them and to their use.

### BACKGROUND OF THE INVENTION

Nitrocellulose or cellulose nitrate or cellulose ester of nitric acid is employed in a very wide variety of application areas by virtue of its diverse, processing-related and end-application properties.

The prior art discloses solvent-borne nitrocellulose compositions as, for example, furniture varnishes, printing inks or overprint varnishes. These coating materials are exclusively organic solvent-containing systems.

Nail varnishes as well frequently have essentially a nitrocellulose parent structure in the binder. Here too it is predominantly organic solvents such as ethyl acetate or butyl acetate, for example, that are employed.

In many cases, however, there is a desire, based on statutory requirements and also based on considerations of protection at work, health and the environment, to replace solvent-containing systems by aqueous systems while at the same time wholly or largely retaining the desired positive applications properties.

There have therefore been diverse attempts described in the prior art to provide nitrocellulose-containing coating systems based on an aqueous vehicle medium and to do without a proportion, or all, of organic solvents and coalescence assistants.

In U.S. Pat. No. 5,670,141, for example, nitrocellulose-containing aqueous emulsions are produced initially, for which costly and inconvenient emulsifying steps are needed. Moreover, they also contain solvents or plasticizers. Subsequently the emulsions are then combined with other polymers to form an aqueous system. This produces mixtures of mutually independently produced nitrocellulose, on the one hand, with polymer dispersions, on the other.

A different process becomes apparent, for example, in WO-A 92/01817, where nitrocellulose emulsions and other aqueous systems are applied in succession as a coating to a substrate such as leather, for example, thereby resulting in each case in a plurality of operating steps.

From the prior art such as, for example, JP-A 03 294 370, JP-A 03 247 624 or JP-A 58-83 001, solvent-borne systems based on nitrocellulose and polyurethane are known. The nitrocellulose compositions described therein are used as dispersion media for magnetic powders.

JP-A 63-14735 discloses aqueous resin emulsions based on water-dispersible, urethane-modified vinyl polymers and nitrocellulose. The vinyl polymer possesses an ionic group and a polyurethane side chain, and serves as a dispersion medium for the nitrocellulose. The compositions described therein are employed as coating materials. The resin emulsion is prepared by dissolving both the vinyl polymer and the nitrocellulose in an organic solvent, then adding water and dispersing the polymer with the use of a neutralizing agent. The organic solvent can be removed before or after the dispersion. A disadvantage of these systems is their poor storage stability if the amount of solvent is reduced considerably by distillation.

Owing to the pronounced hydrophobic nature of nitrocellulose, the processes of the prior art have not succeeded in fully replacing organic solvents and coalescence assistants by water while retaining the level of properties. In particular there has been no description of aqueous dispersions comprising nitrocellulose-polyurethane-urea particles.

### SUMMARY OF THE INVENTION

It was an object of the present invention, therefore, to provide stable and sedimentation-free aqueous dispersions on the basis of a polyurethane polymer and nitrocellulose which have residual organic solvent amounts of less than or equal to 1% by weight with respect to the dispersion and, furthermore, contain no additional external emulsifiers or external migratable plasticizers. On drying, the coating materials prepared from the dispersions of the invention ought to be sufficiently film-forming and (mechanically) stable to allow them to be used to formulate coverings, coatings, sizes, varnishes, adhesives, binders, printing inks, cosmetics articles and personal-care articles and the like for a multiplicity of substrates.

It has now surprisingly been found that dispersions which have not only polyurethane polymer fractions but also nitrocellulose fractions and have an average particle size of 20 nm to 700 nm meet the requirements specified above. These polyurethane-nitrocellulose particles can be used to produce stable, aqueous dispersions without the additional use of plasticizers, emulsifiers or auxiliary solvents.

The invention accordingly provides aqueous dispersions comprising polyurethane-nitrocellulose particles having a particle size of 20 to 700 nm, preferably of 30 to 550 nm, more preferably of 50 to 400 nm and very preferably of 100 to 330 nm and having a polyurethane fraction comprising as its synthesis components compounds selected from the group consisting of
a) organic polyisocyanates,
b) polyols having number-average molar weights of 400 to 8000 g/mol, preferably 400 to 6000 g/mol and more preferably of 600 to 3000 g/mol and having an OH functionality of 1.5 to 6, preferably 1.8 to 3 and more preferably of 1.9 to 2.1,
c) low molecular weight compounds of molar weight 62 to 400 g/mol, preferably 62 to 240 g/mol, more preferably 88 to 140 g/mol, which possess two or more hydroxyl and/or amino groups,
d) low molecular weight compounds which possess a hydroxyl or amino group,
e) isocyanate-reactive compounds which additionally carry ionically or potentially ionically hydrophilicizing groups, and
f) isocyanate-reactive, nonionically hydrophilicizing compounds and also a fraction of water-insoluble nitrocellulose.

The water-insoluble nitrocellulose preferably has a nitrogen fraction of 10.0% to 12.8% by weight, more preferably a nitrogen fraction of 10.7% to 12.6% by weight, very preferably a nitrogen fraction of 10.7% to 12.3% by weight, based on nitrocellulose solids.

The present invention also provides a process for preparing the aqueous dispersion of the invention comprising polyurethane-nitrocellulose particles, characterized in that the synthesis components comprising compounds selected from the group consisting of
a) organic polyisocyanates,
b) polyols having number-average molar weights of 400 to 8000 g/mol, preferably 400 to 6000 g/mol and more preferably of 600 to 3000 g/mol and having an OH functionality of 1.5 to 6, preferably 1.8 to 3 and more preferably of 1.9 to 2.1,
c) low molecular weight compounds of molar weight 62 to 400 g/mol, preferably 62 to 240 g/mol, more preferably 88 to 140 g/mol, which possess two or more hydroxyl and/or amino groups,
d) low molecular weight compounds which possess a hydroxyl or amino group,
e) isocyanate-reactive compounds which additionally carry ionically or potentially, ionically hydrophilicizing groups, and
f) isocyanate-reactive, nonionically hydrophilicizing compounds,
   are reacted in such a way as to prepare first of all an isocyanate-functional prepolymer free from urea groups which is in solution in a solvent which is of infinite miscibility with water, has a boiling point under atmospheric pressure of 40 to 100° C. and reacts not at all or only very slowly with the synthesis components, the amount-of-substance ratio of isocyanate groups to isocyanate-reactive groups being 1.05 to 3.5, preferably 1.2 to 3.0, more preferably 1.3 to 2.5, subsequently the remaining isocyanate groups are amino-functionally chain-extended or chain-terminated, and the nitrocellulose, which is in solution in a solvent which is of infinite miscibility with water, has a boiling point under atmospheric pressure of 40 to 100° C. and reacts not at all or only very slowly with the synthesis components, is added during the dissolving step after preparation of the prepolymer before (i) or after (ii) the chain extension but before the dispersing or after the dispersing before the distillation (iii).

Suitable polyisocyanates of component a) are the aromatic, araliphatic, aliphatic or cycloaliphatic polyisocyanates with an NCO functionality of preferably 2 that are known to the skilled person.

### DETAILED DESCRIPTION OF THE INVENTION

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

Examples of suitable polyisocyanates are 1,4-butylene diisocyanate, 1,6-hexa-methylene diisocyanate (HDI), isophorone diisocyanate (IPDI), 2,2,4- and/or 2,4,4-trimethylhexamethylene diisocyanate, the isomeric bis(4,4′-isocyanato-cyclohexyl)methanes or their mixtures with any desired isomer content, 1,4-cyclohexylene diisocyanate, 1,4-phenylene diisocyanate, 2,4- and/or 2,6-tolylene diisocyanate, 1,5-naphthylene diisocyanate, 2,4′- or 4,4′-diphenylmethane diisocyanate, 1,3- and 1,4-bis(2-isocyanatoprop-2-yl)benzene (TMXDI), 1,3-bis(isocyanatomethyl)benzene (XDI), (S)-alkyl 2,6-diisocyanatohexanoate or (L)-alkyl 2,6-diisocyanatohexanoate.

Proportionally it is also possible to use polyisocyanates having an NCO functionality of greater than 2. These include modified diisocyanates having a uretdione, isocyanurate, urethane, allophanate, biuret, iminooxadiazinedione and/or oxadiazinetrione structure, and also unmodified polyisocyanate containing more than 2 NCO groups per molecule, such as 4-isocyanatomethyl-1,8-octane-diisocyanate (nonane triisocyanate) or triphenylmethane 4,4′,4″-triisocyanate.

Polyisocyanates or polyisocyanate mixtures of the aforementioned kind are preferably those with exclusively aliphatically and/or cycloaliphatically attached isocyanate groups, with an average functionality of 2 to 4, preferably 2 to 2.6 and more preferably of 2 to 2.4.

Particular preference is given to hexamethylene diisocyanate, isophorone diisocyanate, the isomeric bis(4,4′-isocyanatocyclohexyl)methanes, and mixtures thereof.

Polymeric polyols which can be used as compounds b) have a molecular weight. Mn of 400 to 8000 g/mol, preferably 400 to 6000 g/mol and more preferably of 600 to 3000 g/mol. Their hydroxyl number is 22 to 400 mg KOH/g, preferably 30 to 200 mg KOH/g and more preferably 40 to 160 mg KOH/g, and they have an OH functionality of 1.5 to 6, preferably of 1.8 to 3 and more preferably of 1.9 to 2.1.

Polyols in the sense of the present invention are the organic polyhydroxy compounds known in polyurethane coating technology, such as, for example, the typical polyester polyols, polyacrylate polyols, polyurethane polyols, poly-carbonate polyols, polyether polyols, polyester polyacrylate polyols and polyurethane polyacrylate polyols, polyurethane polyester polyols, polyurethane polyether polyols, polyurethane polycarbonate polyols, polyester polycarbonate polyols, alone or in mixtures.

Preferred polyols are polyester polyols, such as, for example, the conventional polycondensates of diols and also, where appropriate triols and tetraols, and dicarboxylic and also, where appropriate, tricarboxylic and tetracarboxylic acids or hydroxycarboxylic acids or lactones. Instead of the free polycarboxylic acids it is also possible to use the corresponding polycarboxylic anhydrides or corresponding polycarboxylic esters of lower alcohols to prepare the polyesters.

Examples of suitable diols are ethylene glycol, butylene glycol, diethylene glycol, triethylene glycol, polyalkylene glycols such as polyethylene glycol, and also 1,2-propanediol, 1,3-propanediol, butane-1,3-diol, butane-1,4-diol, hexane-1,6-diol and isomers, neopentyl glycol, the three last-mentioned compounds being preferred. Polyols for possible additional use here are, for example, trimethylol-propane, glycerol, erythritol, pentaerythritol, or trishydroxyethyl isocyanurate.

Examples of suitable dicarboxylic acids include the following: phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, maleic acid, fumaric acid, itaconic acid, malonic acid, suberic acid, 2-methylsuccinic acid and also their possible anhydrides. For the purposes of the present invention the anhydrides, consequently, are encompassed by the expression “acid”. It is also possible to use monocarboxylic acids, such as benzoic acid and hexanecarboxylic acids, provided that the average OH functionality of the polyol is ≧2. Saturated aliphatic or aromatic acids are preferred, such as adipic acid or isophthalic acid. As a polycarboxylic acid which can be used as well where appropriate in relatively small amounts, mention may be made here of trimellitic acid.

Hydroxycarboxylic acids, which can be used additionally as reaction participants when preparing a polyester polyol having terminal hydroxyl groups, are hydroxycaproic acid or hydroxybutyric acid, for example. Suitable lactones are, for example, caprolactone, butyrolactone and homologues thereof.

Particularly preferred polyester polyols are hexanediol-adipic esters, butanediol-adipic esters, hexanediol-neopentyl glycol-adipic esters and hexanediol-phthalic esters.

Likewise preferred as compounds b) are hydroxyl-containing polycarbonates of molecular weight Mn from 400 to 6000 g/mol, preferably from 600 to 3000 g/mol, which are obtainable, for example, by reaction of carbonic acid derivatives, such as diphenyl carbonate, dimethyl carbonate or phosgene, with polyols, preferably diols.

Examples of suitable such diols include ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenol A, tetrabromobisphenol A but also lactone-modified diols. The diol component preferably contains 40% to 100% by weight of 1,6-hexanediol. Proportionally it is also possible to use hexanediol derivatives, preferably those which as well as terminal OH groups have ether groups or ester groups, examples being products that can be obtained by reacting 1 mol of hexanediol with at least 1 mol, preferably 1 to 2 mol, of caprolactone or by etherifying hexanediol with itself to form the dihexylene or trihexylene glycol.

Polyether polycarbonate diols as well can be used. The hydroxyl polycarbonates ought to be substantially linear. Where appropriate, however, they can be slightly branched as a result of the incorporation of polyfunctional components, especially low molecular weight polyols.

Further suitable polyol components b) include polyether polyols, examples being the polyaddition products of the styrene oxides, of ethylene oxide, of propylene oxide, of tetrahydrofuran, of butylene oxide, of epichlorohydrin, and also their coadducts and grafting products, and also the polyether polyols obtained by condensing polyhydric alcohols or mixtures thereof and the polyether polyols obtained by alkoxylating, polyfunctional alcohols, amines and amino alcohols.

The low molecular weight polyols c) used for synthesizing the polyurethane resins generally have the effect of stiffening and or of branching the polymer chain and are employed preferably during the prepolymer synthesis. The molecular weight is situated preferably between 62 and 400 g/mol, more preferably between 62 and 200 g/mol. Suitable polyols c) may contain aliphatic, alicyclic or aromatic groups. Mention may be made here, by way of example, of the low molecular weight polyols having up to about 20 carbon atoms per molecule, such as ethylene glycol, diethylene glycol, triethylene glycol, 1,2-propanediol, 1,3-propanediol, 1,4-butanediol, cyclohexanediol, 1,4-cyclohexanedimethanol, 1,6-hexanediol, neopentyl glycol, bisphenol A (2,2-bis(4-hydroxycyclohexyl)propane), hydrogenated bisphenol A (2,2-bis(4-hydroxycyclohexyl)propane), and also trimethylolpropane, glycerol or pentaerythritol and mixtures of these and, where appropriate, of further low molecular weight polyols c) as well. Preference is given to 1,4-butanediol, 1,6-hexanediol, neopentyl glycol and trimethylolpropane.

For the chain extension of the NCO-terminated prepolymer it is possible to use diamines or polyamines and also hydrazides as component c), examples being ethylenediamine, 1,2- and 1,3-diaminopropane, 1,4-diaminobutane, 1,6-diamino-hexane, isophoronediamine, isomer, mixture of 2,2,4- and 2,4,4-trimethylhexa-methylenediamine, 2-methylpentamethylenediamine, diethylenetriamine, and 4,4-diaminodicyclohexylmethane, dimethylethylenediamine, hydrazine or adipic dihydrazide. Preference is given to ethylenediamine, diethylenetriamine, isophoronediamine and hydrazine.

Also suitable in principle as component c) are compounds which contain active hydrogen with different reactivity towards isocyanate groups, such as compounds which as well as a primary amino group also have secondary amino groups or as well as an amino group (primary or secondary) also have OH groups. Examples thereof are primary/secondary amines, such as 3-amino-1-methylaminopropane, 3-amino-1-ethylaminopropane, 3-amino-1-cyclohexylaminopropane, 3-amino-1-methylaminobutane, additionally alkanolamines such as N-aminoethyl-ethanolamine, ethanolamine, 3-aminopropanol, neopentanolamine and, with particular preference, diethanolamine, N-(2-hydroxyethyl)ethylenediamine, N,N′-bis(2-hydroxyethyl)ethylenediamine. These can be used as chain extenders and/or as chain termination when preparing the dispersion of the invention.

The dispersions of the invention may where appropriate include constituent units d) which are located in each case at the chain ends and close off these ends. These units are derived on the one hand from monofunctional compounds reactive with NCO groups, such as monoamines, especially mono-secondary amines, or monoalcohols. Preference is given to ethanol, n-butanol, 2-ethylhexanol, propylamine, butylamine, stearylamine or dibutylamine.

Suitable ionically or potentially ionically hydrophilicizing compounds e) are compounds which have at least one isocyanate-reactive group and also at least one functionality, such as —COO⁻Y⁺, —SO₃⁻Y⁺, —PO(O⁻Y⁺)₂ (Y⁺ for example=H⁺, NH₄⁺, metal cation), which on interaction with aqueous media enter into a pH-dependent dissociation equilibrium and in that way may be negatively charged or neutral. Preferred isocyanate-reactive groups are hydroxyl or amino groups.

Suitable anionically or potentially anionically hydrophilicizing compounds in accordance with the definition of component e) are, for example, mono- and dihydroxycarboxylic acids, mono- and diaminocarboxylic acids, mono- and dihydroxysulphonic acids, mono- and diaminosulphonic acids and also mono- and dihydroxyphosphonic acids or mono- and diaminophosphonic acids and their salts such as dimethylolpropionic acid, dimethylolbutyric acid, hydroxypivalic acid, N-(2-aminoethyl)-β-alanine, 2-(2-aminoethylamino)ethanesulphonic acid, ethylenediaminepropylsulphonic or -butylsulphonic acid, 1,2- or 1,3-propylene-diamine-β-ethylsulphonic acid, malic acid, citric acid, glycolic acid, lactic acid, glycine, alanine, taurine, lysine, 3,5-diaminobenzoic acid, an adduct of IPDI and acrylic acid (EP-A 0 916 647, Example 1) and its alkali metal and/or ammonium salts; polyethersulphonate, the propoxylated adduct of 2-butenediol and NaHSO₃, described for example in DE-A 2 446 440 (pages 5-9, formula I-III). Additionally it is possible for cyclohexylaminopropanesulphonic acid (CAPS) to be used, as for example in WO-A 01/88006, as a compound in accordance with the definition of component 5).

Preferred compounds e) are those possessing carboxyl or carboxylate and/or sulphonate groups. Particularly preferred ionic compounds 5) are those which contain carboxyl and/or sulphonate groups as ionic or potentially ionic groups, such as the salts of N-(2-aminoethyl)-β-alanine, of 2-(2-aminoethyl-amino)ethanesulphonic acid or of the adduct of IPDI and acrylic acid (EP-A 0 916 647, Example 1) and also dimethylolpropionic acid.

Suitable nonionically hydrophilicizing compounds in accordance with the definition of component f) are, for example, polyoxyalkylene ethers which contain at least one hydroxyl or amino group. These polyethers include a fraction of 30% by weight to 100% by weight of units derived from ethylene oxide.

Examples of nonionically hydrophilicizing compounds f) also include monofunctional polyalkylene oxide polyether alcohols containing on average 5 to 70, preferably 7 to 55, ethylene oxide units per molecule, of the kind obtainable in a conventional manner by alkoxylating suitable starter molecules.

The polyalkylene oxide polyether alcohols are either pure polyethylene oxide polyethers or mixed polyalkylene oxide polyethers at least 30 mol %, preferably at least 40 mol %, of whose alkylene oxide units are composed of ethylene oxide units. Particularly preferred nonionic compounds are monofunctional mixed polyalkylene oxide polyethers which contain at least 40 mol % of ethylene oxide units and not more than 60 mol % of propylene oxide units.

Examples of suitable starter molecules are diethylene glycol monobutyl ether or n-butanol. Alkylene oxides suitable for the alkoxylation reaction are, in particular, ethylene oxide and propylene oxide, which can be used in either order or else in a mixture in the alkoxylation reaction.

Preference is given to using 5% to 40% by weight of component a), 55% to 94% by weight of b), 0.5% to 20% by weight of the sum of compounds c) and d), 0.1% to 5% by weight of component e), 0% to 20% by weight of component f), the sum of e) and f) being 0.1% to 25% by weight, and the sum of all the components adding up to 100% by weight.

Particular preference is given to using 5% to 35% by weight of component a), 60% to 90% by weight of b), 0.5% to 15% by weight of the sum of compounds c) and d), 0.1% to 4% by weight of component e), 0% to 15% by weight of component f), the sum of e) and f) being 0.1% to 19% by weight, and the sum of all the components adding up to 100% by weight.

Very particular preference is given to using 10% to 30% by weight of component a), 65% to 85% by weight of b), 0.5% to 14% by weight of the sum of compounds c) and d), 0.1% to 3.5% by weight of component e), 0% to 10% by weight of component f), the sum of e) and f) being 0.1% to 13.5% by weight, and the sum of all the components adding up to 100% by weight.

Suitable nitrocellulose is water-insoluble nitrocellulose at all viscosity levels. Of preferential suitability are nitrocelluloses which feature, for example, the typical collodion grades (on the term “Collodion” cf. Römpp's Chemielexikon, Thieme Verlag, Stuttgart), i.e. cellulose-nitric esters, having a nitrogen content of 10% to 12.8% by weight, which are soluble in the process solvent or process-solvent mixture.

Particular preference is given to cellulose-nitric esters having a nitrogen content of 10.7% to 12.6%, very preferably of 10.7% to 12.3% by weight. Examples of cellulose-nitric esters of this kind are the Walsroder® nitrocellulose A products (Wolff Cellulosics GmbH & Co. KG, Bomlitz DE) having a nitrogen content of 10.7% to 11.3% by weight, or Walsroder® nitrocellulose AM products (Wolff Cellulosics GmbH & Co. KG, Bomlitz DE), which have a nitrogen content of 11.3% to 11.8% by weight, or Walsroder® nitrocellulose E products (Wolff Cellulosics GmbH & Co. KG, Bomlitz DE), having a nitrogen content of 11.8% to 12.3% by weight.

Within the aforementioned cellulose-nitric esters of defined nitrogen content all viscosity levels are suitable in each case. Low-viscosity cellulose-nitric esters with different nitrogen contents are classified into the following groups in accordance with ISO 14446: ≧30A, ≧30M, ≧30E. Medium-viscosity cellulose-nitric esters with different nitrogen contents are classified into the following groups in accordance with ISO 14446: 18 E to 29 E, 18 M to 29 M, 18 A to 29 A. High-viscosity cellulose-nitric esters with different nitrogen contents are in accordance with ISO 14446 as follows: ≦17 E, ≦17 M and ≦17 A.

It is also possible to use mixtures of different types of the abovementioned suitable cellulose-nitric esters.

The nitrocellulose is supplied commercially generally in stabilized form. Examples of typical stabilizers are alcohols or water. The amount of stabilizers is between 5% to 40% by weight. To prepare the dispersions of the invention it is preferred to use nitrocelluloses which have been damped with alcohols or water. In one particularly preferred form nitrocellulose is used which has been damped with 10% to 40% by weight of isopropanol (based on the total mass of the as-supplied form). Examples that may be mentioned include “Walsroder® nitrocellulose E 560 isopropanol 30%” or “Walsroder® nitrocellulose A 500 isopropanol 30%” or “Walsroder® nitrocellulose E 560 water 30%”.

The process for preparing the dispersions of the invention can be carried out in one or more stages in a homogeneous phase or, in the case of multi-stage reaction, partly in disperse phase. After full or partial polyaddition of a)-f) there is a dispersing, emulsifying or dissolving step. Subsequently there is, where appropriate, a further polyaddition or modification in disperse phase.

To prepare the dispersions of the invention the acetone process is used, which is known from the prior art for the preparation of PU dispersions.

For preparing the dispersion of the invention by the acetone method it is usual to introduce some or all of the constituents b) to f), which should not contain any primary or secondary amino groups, and the polyisocyanate components a) for preparing an isocyanate-functional polyurethane prepolymer, in an initial charge, to dilute this initial charge, where appropriate, with a water-miscible solvent which is nevertheless inert towards isocyanate groups, and to heat it at temperatures in the range from 50 to 120° C. To accelerate the isocyanate addition reaction the catalysts known in polyurethane chemistry can be used.

Suitable solvents are of infinite miscibility with water and have a boiling point under atmospheric pressure of 40 to 100° C. and react not at all or only very slowly with the synthesis components. Particular suitability is possessed by tetrahydro-furan and the typical aliphatic, keto-functional solvents such as acetone, 2-butanone or tetrahydrofuran, for example, which can be added not only at the beginning of the preparation but also, where appropriate, in portions later on as well. Acetone and 2-butanone are preferred. Acetone is particularly preferred. Subsequently any constituents of a)-f) not added at the beginning of the reaction are metered in.

In the preparation of the polyurethane prepolymer the amount-of-substance ratio of isocyanate groups to isocyanate-reactive groups is 1.05 to 3.5, preferably 1.1 to 3.0, more preferably 1.1 to 2.5.

The reaction of components a)-f) to form the prepolymer takes place partially or completely, but preferably completely. In this way polyurethane prepolymers containing free isocyanate groups are obtained in bulk (without solvent) or in solution.

The preparation of the polyurethane prepolymers is accompanied or followed—if this has not already been carried out in the starting molecules—by the partial or complete formation of salts of the potentially anionically dispersing groups. In the case of potentially anionic groups this is done using bases such as tertiary amines, examples being trialkylamines having 1 to 12, preferably 1 to 6, carbon atoms in each alkyl radical. Examples thereof are trimethylamine, triethylamine, methyldiethylamine, tripropylamine, N-methylmorpholine, methyldiisopropyl-amine, ethyldiisopropylamine and diisopropylethylamine. The alkyl radicals may for example also carry hydroxyl groups, as in the case of the dialkylmono-alkanolamines, alkyldialkanolamines and trialkanolamines. Neutralizing agents which can be used also include inorganic bases, such as aqueous ammonia solution or sodium and/or potassium hydroxide. Those preferred are ammonia, triethylamine, triethanolamine, dimethylethanolamine, diisopropylethylamine, sodium hydroxide or potassium hydroxide.

The amount of substance of the bases is situated between 50% and 125%, preferably between 70% and 100%, of the amount of substance of the acid groups for neutralization. Neutralization may also take place at the same time as dispersion, by virtue of the neutralizing agent already being present in the dispersion water.

Subsequently, in a further process step, if it has not already taken place or has taken place only partially, the resulting prepolymer is dissolved by means of aliphatic ketones such as acetone or 2-butanone.

This is followed by the reaction of possible NH₂— and/or NH-functional components c) to e) with the remaining isocyanate groups. This chain extension/termination may be carried out alternatively in solvent prior to the dispersion, during the dispersion, or in water after the dispersion. Preferably the chain extension is carried out prior to the dispersion in water.

Where chain extension is carried out using compounds in accordance with the definition of e) having NH₂ or NH groups, the prepolymers are chain-extended preferably before the dispersion.

The degree of chain extension, i.e. the equivalent ratio of NCO-reactive groups of the compounds used for chain extension to free NCO groups of the prepolymer, is between 40% to 150%, preferably between 50% to 120%, more preferably between 60% to 120%.

The aminic components [c), d), f)] may where appropriate be used in water- or solvent-diluted form in the process of the invention, individually or in mixtures, with any sequence of addition being possible in principle.

If water or organic solvents are used as diluents, the diluent content is preferably 70% to 95% by weight.

The preparation of the dispersion of the invention from the prepolymers takes place following the chain extension. For this purpose the dissolved and chain-extended polyurethane polymer, where appropriate with strong shearing, such as vigorous stirring, for example, is introduced into the dispersion water or, conversely, the dispersion water is stirred into the prepolymer solutions. It is preferred to introduce the water into the dissolved prepolymer.

The solvent still present in the dispersions after the dispersion step is typically then removed by distillation. Its removal actually during dispersion is likewise possible. The dispersions of the invention generally have a residual solvent content of ≦3% by weight, preferably ≦1% by weight.

The nitrocellulose is preferably dissolved in keto-functional organic solvents such as acetone or 2-butanone before addition to the prepolymer. With particular preference the nitrocellulose is dissolved in acetone. The amount of nitrocellulose in the acetonic solution is 5% to 95%, preferably 5% to 70% and more preferably 5% to 50% by weight.

The addition of the acetonic nitrocellulose solution may be made during the dissolving step after preparation of the prepolymer (i) before or after the chain extension (ii) before the dispersion or after the dispersion (iii) before the distillation.

The addition of the dissolved nitrocellulose takes place preferably after preparation of the prepolymer (i), i.e. before or after the chain extension step (ii), but before the dispersion (iii).

In one particularly preferred embodiment the addition of the dissolved nitrocellulose takes place after the chain extension step (ii) before the dispersion (iii).

The amount of nitrocellulose in the resultant dispersion of the invention, based on total solids, is 0.5% to 85%, preferably 5% to 75%, more preferably 10% to 60% by weight.

The solids content of the dispersion of the invention is between 10% to 70%, preferably between 20% to 65% and more preferably between 30% to 63% by weight.

The polyurethane-nitrocellulose particles of the dispersions of the invention have an average particle size between 20 and 700 nm, preferably between 30 and 550 nm, more preferably between 50 and 400 nm and very preferably between 100 and 330 nm.

The dispersions of the invention may further comprise antioxidants and/or light stabilizers and/or auxiliaries and adjuvants such as, for example, defoamers and thickeners. Finally it is also possible for fillers, non-migratable plasticizers, pigments, silica sols, aluminium dispersions, clay dispersions, flow control agents or thixotropic agents to be present. Depending on the desired pattern of properties and the end use of the dispersions of the invention it is possible for there to be up to 70%, based on total solids, of such fillers in the end product.

The aqueous dispersions of the invention can be used for example in single-coat coating materials or in the clearcoat or topcoat layer (topmost layer) of multilayer systems.

The production of the coating may take place by any of a very wide variety of spraying techniques, such as, for example, air-pressure spraying, airless spraying or electrostatic spraying techniques, using one-component or, where appropriate, two-component spraying units. The coating materials comprising the dispersions of the invention may alternatively be applied by other methods, such as by brushing, rolling, casting, knife coating, dipping, printing or other methods known from the prior art, for example.

The present invention also provides coating materials comprising dispersions of the invention.

The present invention provides for the use of the dispersions of the invention for producing products in the sector of cosmetics.

Additionally provided by the present invention is the use of the dispersions of the invention for producing coated substrates.

Examples of suitable substrates include woven and non-woven textiles, leather, paper, hard fibres, paperlike materials, wood, glass, plastics of a very wide variety of kinds, ceramics, stone, concrete, bitumen, metals, glass fibres or carbon fibres. The dispersions of the invention are likewise suitable for producing sizes, adhesive systems or printing inks.

The present invention provides, furthermore, a substrate construction comprising one or more layers which are coated, adhesively bonded or bound with the dispersions of the invention.

The dispersions of the invention are stable and storable.

### EXAMPLES

Substances Used and Abbreviations:

Diaminosulphonate: NH₂—CH₂CH₂—NH—CH₂CH₂—SO₃Na (45% strength in water
Desmophen® 2020/C2200: polycarbonate polyol, OH number 56 mg KOH/g, number-average molecular weight 2000 g/mol (Bayer MaterialScience AG, Leverkusen, DE)
PolyTHF® 2000: polytetramethylene glycol polyol, OH number 56 mg/KOH/g, number-average molecular weight 2000 g/mol (BASF AG, Ludwigshafen, DE)
PolyTHF® 1000: polytetramethylene glycol polyol, OH number 112 mg/KOH/g, number-average molecular weight 1000 g/mol (BASF AG, Ludwigshafen, DE)
Polyether LB 25: monofunctional polyether based on ethylene oxide/propylene oxide with a number-average molecular weight 2250 g/mol, OH number 25 mg KOH/g (Bayer Materialscience Ag, Leverkusen, De)
IPA: isopropanol
Desmodur® W bis(4,4′-isocyanatocyclohexyl)methane (Bayer Materialscience Ag, Leverkusen, De)
   Walsroder® Nitrocellulose E330/IPA 30%:
   low-viscosity nitrocellulose with a nitrogen content between 11.8% to 12.3%, ISO 14446: 34 E, Wolff Cellulosics GmbH & Co. KG, Bomlitz DE
   Walsroder® Nitrocellulose E1160/IPA 30%:
   high-viscosity nitrocellulose with a nitrogen content between 11.8% to 12.3%, ISO 14446: 7 E, Wolff Cellulosics GmbH & Co. KG, Bomlitz DE
   Walsroder® Nitrocellulose A500/IPA 30%:
   high-viscosity nitrocellulose with a nitrogen content between 10.7% to 11.3%, ISO 14446: 27 A, Wolff Cellulosics GmbH & Co. KG, Bomlitz DE
   Walsroder® Nitrocellulose E560/IPA 30%:
   medium-viscosity nitrocellulose with a nitrogen content between 11.8% to 12.3%, ISO 14446: 23 E, Wolff Cellulosics GmbH & Co. KG, Bomlitz DE
   Walsroder® Nitrocellulose E 560/water 30%
   medium-viscosity cellulose with a nitrogen content between 11.8% to 12.3%, ISO 14446: E 23, Wolff Cellulosics GmbH & Co. KG, Bomlitz DE)

The solids contents were determined in accordance with DIN-EN ISO 3251.

Unless expressly mentioned otherwise, NCO contents were determined volumetrically in accordance with DIN-EN ISO 11909.

The average particle sizes of the dispersions were determined by means of laser correlation spectroscopy measurements (Zetasizer 1000, Malvern Instruments, Malvern, UK).

The OH numbers were determined in accordance with DIN 53240-2.

The nitrogen contents stated for the nitrocellulose in % by weight refer to the nitrocellulose solids.

Variation of Nitrocellulose Products:

### Example 1

### 10% Walsroder® Nitrocellulose E330/IPA 30%

310.3 g of a difunctional polyesterpolyol based on adipic acid and hexanediol and neopentyl glycol (average molecular weight 1700 g/mol, OHN=66 mg KOH/g solids) were heated to 65° C. Subsequently at 65° C. 54.9 g of hexamethylene diisocyanate were added over the course of 5 minutes and the mixture was stirred at 100° C. until the theoretical NCO value of 3.3% was reached. The finished prepolymer was dissolved with 503.8 g of acetone at 50° C. and subsequently a solution of 20.6 g of diaminosulphonate, 3.2 g of ethylenediamine and 102.7 g of water was metered in over the course of 5 minutes. The subsequent stirring time was 15 minutes. Subsequently over the course of 5 minutes a solution of 59.9 g of Walsroder® Nitrocellulose E330/IPA 30% and 145.3 g of acetone was added. Dispersion took place by addition of 515.3 g of water over the course of 10 minutes. In a subsequent distillation step the solvents were removed under reduced pressure to give a storage-stable PU dispersion having a solids content of 40.9% and an average particle size of 196 nm.

### Example 2

### 30% Walsroder® Nitrocellulose E330/IPA 30%

233.8 g of a difunctional polyesterpolyol as per Example 1 were heated to 65° C. Subsequently at 65° C. 41.3 g of hexamethylene diisocyanate were added over the course of 5 minutes and the mixture was stirred at 100° C. until the theoretical NCO value of 3.3% was reached. The finished prepolymer was dissolved with 400 g of acetone at 50° C. and subsequently a solution of 15.6 g of diaminosulphonate, 2.4 g of ethylenediamine and 77.3 g of water was metered in over the course of 5 minutes. The subsequent stirring time was 15 minutes. Subsequently over the course of 5 minutes a solution of 174.2 g of Walsroder® Nitrocellulose E330/IPA 30% and 422.4 g of acetone was added. Dispersion took place by addition of 523.7 g of water over the course of 10 minutes. In a subsequent distillation step the solvents were removed under reduced pressure to give a storage-stable PU dispersion having a solids content of 39.9% and an average particle size of 156 nm.

### Example 3

### 10% Walsroder® Nitrocellulose E1160/IPA 30%

310.3 g of a difunctional polyesterpolyol as per Example 1 were heated to 65° C. Subsequently at 65° C. 54.9 g of hexamethylene diisocyanate were added over the course of 5 minutes and the mixture was stirred at 100° C. until the theoretical NCO value of 3.3% was reached. The finished prepolymer was dissolved with 341.5 g of acetone at 50° C. and subsequently a solution of 20.6 g of diaminosulphonate, 3.2 g of ethylenediamine and 102.7 g of water was metered in over the course of 5 minutes. The subsequent stirring time was 15 minutes. Subsequently over the course of 5 minutes a solution of 59.9 g of Walsroder® Nitrocellulose E1160/IPA 30 and 307.7 g of acetone was added. Dispersion took place by addition of 515.3 g of water over the course of 10 minutes. In a subsequent distillation step the solvents were removed under reduced pressure to give a storage-stable PU dispersion having a solids content of 38.0% and an average particle size of 314 nm.

### Example 4

### 30% Walsroder® Nitrocellulose E1160/IPA 30%

233.8 g of a difunctional polyesterpolyol as per Example were heated to 65° C. Subsequently at 65° C. 41.3 g of hexamethylene diisocyanate were added over the course of 5 minutes and the mixture was stirred at 100° C. until the theoretical NCO value of 3.3% was reached. The finished prepolymer was dissolved with 322.9 g of acetone at 50° C. and subsequently a solution of 20.2 g of diaminosulphonate, 2.4 g of ethylenediamine and 77.3 g of water was metered in over the course of 5 minutes. The subsequent stirring time was 15 minutes. Subsequently over the course of 5 minutes a solution of 175.5 g of Walsroder® Nitrocellulose E1160/IPA 30% and 900.7 g of acetone was added. Dispersion took place by addition of 525.6 g of water over the course of 10 minutes. In a subsequent distillation step the solvents were removed under reduced pressure to give a storage-stable PU dispersion having a solids content of 38.0% and an average particle size of 523 nm.

### Example 5

### 10% Walsroder® Nitrocellulose A500/IPA 30%

310.3 g of a difunctional polyesterpolyol as per Example were heated to 65° C. Subsequently at 65° C. 54.9 g of hexamethylene diisocyanate were added over the course of 5 minutes and the mixture was stirred at 100° C. until the theoretical NCO value of 3.3% was reached. The finished prepolymer was dissolved with 411.4 g of acetone at 50° C. and subsequently a solution of 20.6 g of diaminosulphonate, 3.2 g of ethylenediamine and 102.7 g of water was metered in over the course of 5 minutes. The subsequent stirring time was 15 minutes. Subsequently over the course of 5 minutes a solution of 59.9 g of Walsroder® Nitrocellulose A500/IPA 30% and 167.8 g of acetone was added. Dispersion took place by addition of 515.3 g of water over the course of 10 minutes. In a subsequent distillation step the solvents were removed under reduced pressure to give a storage-stable PU dispersion having a solids content of 42.0% and an average particle size of 283 nm.

### Example 6

### 30% Walsroder® Nitrocellulose A500/IPA 30%

233.8 g of a difunctional polyesterpolyol as per Example 1 were heated to 65° C. Subsequently at 65° C. 41.3 g of hexamethylene diisocyanate were added over the course of 5 minutes and the mixture was stirred at 100° C. until the theoretical NCO value of 3.3% was reached. The finished prepolymer was dissolved with 322.9 g of acetone at 50° C. and subsequently a solution of 20.2 g of diaminosulphonate, 2.4 g of ethylenediamine and 77.3 g of water was metered in over the course of 5 minutes. The subsequent stirring time was 15 minutes. Subsequently over the course of 5 minutes a solution of 175.5 g of Walsroder® Nitrocellulose A 500/IPA 30% and 491.3 g of acetone was added. Dispersion took place by addition of 525.6 g of water over the course of 10 minutes. In a subsequent distillation step the solvents were removed under reduced pressure to give a storage-stable PU dispersion having a solids content of 41.0% and an average particle size of 141 nm.

Varying the Nitrocellulose Mass Fraction of the Solids Content

### Example 7

### 20% Walsroder® Nitrocellulose E560/IPA 30%

276.3 g of a difunctional polyesterpolyol as per Example 1 were heated to 65° C. Subsequently at 65° C. 48.9 g of hexamethylene diisocyanate were added over the course of 5 minutes and the mixture was stirred at 100° C. until the theoretical NCO value of 3.3% was reached. The finished prepolymer was dissolved with 381.7 g of acetone at 50° C. and subsequently a solution of 18.4 g of diaminosulphonate, 2.4 g of ethylenediamine and 91.4 g of water was metered in over the course of 5 minutes. The subsequent stirring time was 15 minutes. Subsequently over the course of 5 minutes a solution of 120.1 g of Walsroder® Nitrocellulose E560/IPA 30% and 428.4 g of acetone was added. Dispersion took place by addition of 528.9 g of water over the course of 10 minutes. In a subsequent distillation step the solvents were removed under reduced pressure to give a storage-stable PU dispersion having a solids content of 40.0% and an average particle size of 252 nm.

### Example 8

### 30% Walsroder® Nitrocellulose E560/IPA 30%

233.8 g of a difunctional polyesterpolyol as per Example 1 were heated to 65° C. Subsequently at 65° C. 41.3 g of hexamethylene diisocyanate were added over the course of 5 minutes and the mixture was stirred at 100° C. until the theoretical NCO value of 3.3% was reached. The finished prepolymer was dissolved with 322.9 g of acetone at 50° C. and subsequently a solution of 20.2 g of diaminosulphonate, 2.4 g of ethylenediamine and 77.3 g of water was metered in over the course of 5 minutes. The subsequent stirring time was 15 minutes. Subsequently over the course of 5 minutes a solution of 175.5 g of Walsroder® Nitrocellulose E560/IPA 30 and 696.0 g of acetone was added. Dispersion took place by addition of 525.6 g of water over the course of 10 minutes. In a subsequent distillation step the solvents were removed under reduced pressure to give a storage-stable PU dispersion having a solids content of 41.0% and an average particle size of 160 nm.

### Example 9

### 40% Walsroder® Nitrocellulose E560/IPA 30%

199.8 g. of a difunctional polyesterpolyol as per Example 1 were heated to 65° C. Subsequently at 65° C. 35.3 g of hexamethylene diisocyanate were added over the course of 5 minutes and the mixture was stirred at 100° C. until the theoretical NCO value of 3.3% was reached. The finished prepolymer was dissolved with 276.0 g of acetone at 50° C. and subsequently a solution of 17.3 g of diaminosulphonate, 2.0 g of ethylenediamine and 66.1 g of water was metered in over the course of 5 minutes. The subsequent stirring time was 15 minutes. Subsequently over the course of 5 minutes a solution of 233.2 g of Walsroder® Nitrocellulose E560/IPA 30% and 925.1 g of acetone was added. Dispersion took place by addition of 536.6 g of water over the course of 10 minutes. In a subsequent distillation step the solvents were removed under reduced pressure to give a storage-stable PU dispersion having a solids content of 40.0% and an average particle size of 261 nm.

### Example 10

### 50% Walsroder® Nitrocellulose E560/IPA 30%

114.8 g of a difunctional polyesterpolyol as per Example 1 were heated to 65° C. Subsequently at 65° C. 20.3 g of hexamethylene diisocyanate were added over the course of 5 minutes and the mixture was stirred at 100° C. until the theoretical NCO value of 3.3% was reached. The finished prepolymer was dissolved with 240.1 g of acetone at 50° C. and subsequently a solution of 13.4 g of diaminosulphonate, 0.9 g of ethylenediamine and 38.0 g of water was metered in over the course of 5 minutes. The subsequent stirring time was 15 minutes. Subsequently over the course of 5 minutes a solution of 202.8 g of Walsroder® Nitrocellulose E560/IPA 30% and 804.4 g of acetone was added. Dispersion took place by addition of 380.5 g of water over the course of 10 minutes. In a subsequent distillation step the solvents were removed under reduced pressure to give a storage-stable PU dispersion having a solids content of 42.9% and an average particle size of 172 nm.

### Example 11

### 60% Walsroder® Nitrocellulose E560/IPA 30%

131.8 g of a difunctional polyesterpolyol as per Example 1 were heated to 65° C. Subsequently at 65° C. 23.3 g of hexamethylene diisocyanate were added over the course of 5 minutes and the mixture was stirred at 100° C. until the theoretical NCO value of 3.3% was reached. The finished prepolymer was dissolved with 275.7 g of acetone at 50° C. and subsequently a solution of 17.5 g of diaminosulphonate, 0.7 g of ethylenediamine and 43.6 g of water was metered in over the course of 5 minutes. The subsequent stirring time was 15 minutes. Subsequently over the course of 5 minutes a solution of 350.7 g of Walsroder® Nitrocellulose E560/IPA 30% and 1391.1 g of acetone was added. Dispersion took place by addition of 560.5 g of water over the course of 10 minutes. In a subsequent distillation step the solvents were removed under reduced pressure to give a storage-stable PU dispersion having a solids content of 39.0% and an average particle size of 222 nm.

Process Variants of Nitrocellulose Addition:

### Example 12

### 10% Walsroder® Nitrocellulose E560/IPA 30% (Addition of Nitrocellulose Before the Chain Extension)

280.5 g of a difunctional polyesterpolyol as per Example 1 were heated to 65° C. Subsequently at 65° C. 49.6 g of hexamethylene diisocyanate were added over the course of 5 minutes and the mixture was stirred at 100° C. until the theoretical NCO value of 3.3% was reached. The finished prepolymer was dissolved with 481.3 g of acetone at 50° C. and then a solution of 61.0 g of Walsroder® Nitrocellulose E560/IPA 30% and 170.7 g of acetone was added over the course of 5 minutes. Subsequently a solution of 15.9 g of diaminosulphonate, 2.5 g of ethylenediamine and 92.8 g of water was metered in over the course of 5 minutes. The subsequent stirring time was 15 minutes. Dispersion took place by addition of 473.0 g of water over the course of 10 minutes. In a subsequent distillation step the solvents were removed under reduced pressure to give a storage-stable PU dispersion having a solids content of 37.0% and an average particle size of 269 nm.

### Example 13

### 20% Walsroder® Nitrocellulose E560/IPA 30% (Addition of Nitrocellulose Before the Chain Extension)

276.3 g of a difunctional polyesterpolyol as per Example 1 were heated to 65° C. Subsequently at 65° C. 48.9 g of hexamethylene diisocyanate were added over the course of 5 minutes and the mixture was stirred at 100° C. until the theoretical NCO value of 3.3% was reached. The finished prepolymer was dissolved with 381.7 g of acetone at 50° C. and then a solution of 120.1 g of Walsroder® Nitrocellulose E560/IPA 30% and 428.4 g of acetone was added over the course of 5 minutes. Subsequently a solution of 1.8.4 g of diaminosulphonate, 2.4 g of ethylenediamine and 91.4 g of water was metered in over the course of 5 minutes. The subsequent stirring time was 15 minutes. Dispersion took place by addition of 528.9 g of water over the course of 10 minutes. In a subsequent distillation step the solvents were removed under reduced pressure to give a storage-stable PU dispersion having a solids content of 39.0% and an average particle size of 176 nm.

### Example 14

### 30% Walsroder® Nitrocellulose E560/IPA 30%

233.8 g of a difunctional polyesterpolyol as per Example 1 were heated to 65° C. Subsequently at 65° C. 41.3 g of hexamethylene diisocyanate were added over the course of 5 minutes and the mixture was stirred at 100° C. until the theoretical NCO value of 3.3% was reached. The finished prepolymer was dissolved with 322.9 g of acetone at 50° C. and then a solution of 174.2 g of Walsroder® Nitrocellulose E560/IPA 30% and 690.9 g of acetone was added over the course of 5 minutes. Subsequently a solution of 15.6 g of diaminosulphonate, 2.1 g of ethylenediamine and 77.3 g of water was metered in over the course of 5 minutes. The subsequent stirring time was 15 minutes. Dispersion took place by addition of 523.7 g of water over the course of 10 minutes. In a subsequent distillation step the solvents were removed under reduced pressure to give a storage-stable PU dispersion having a solids content of 39.0% and an average particle size of 388 nm.

### Example 15

### 10% Walsroder® Nitrocellulose E560/IPA 30% (Addition of Nitrocellulose after Dispersion)

310.3 g of a difunctional polyesterpolyol as per Example 1 were heated to 65° C. Subsequently at 65° C. 54.9 g of hexamethylene diisocyanate were added over the course of 5 minutes and the mixture was stirred at 100° C. until the theoretical NCO value of 3.3% was reached. The finished prepolymer was dissolved with 411.4 g of acetone at 50° C. and subsequently a solution of 20.6 g of diaminosulphonate, 3.2 g of ethylenediamine and 102.7 g of water was metered in over the course of 5 minutes. The subsequent stirring time was 15 minutes. Dispersion took place by addition of 515.3 g of water over the course of 10 minutes. Subsequently over the course of 5 minutes a solution of 59.9 g of Walsroder® Nitrocellulose E560/IPA 30% and 297.7 g of acetone was added. In a subsequent distillation step the solvents were removed under reduced pressure to give a storage-stable PU dispersion having a solids content of 38.0% and an average particle size of 260 nm.

### Example 16

### 30% Walsroder® Nitrocellulose E560/IPA 30% (Addition of Nitrocellulose after Dispersion)

233.8 g of a difunctional polyesterpolyol as per Example were heated to 65° C. Subsequently at 65° C. 41.3 g of hexamethylene diisocyanate were added over the course of 5 minutes and the mixture was stirred at 100° C. until the theoretical NCO value of 3.3% was reached. The finished prepolymer was dissolved with 753.4 g of acetone at 50° C. and subsequently a solution of 15.6 g of diaminosulphonate, 2.4 g of ethylenediamine and 77.3 g of water was metered in over the course of 5 minutes. The subsequent stirring time was 15 minutes. Dispersion took place by addition of 523.7 g of water over the course of 10 minutes. Subsequently over the course of 5 minutes a solution of 174.2 g of Walsroder® Nitrocellulose E560/IPA 30% and 690.9 g of acetone was added. In a subsequent distillation step the solvents were removed under reduced pressure to give a storage-stable PU dispersion having a solids content of 38.0% and an average particle size of 376 nm.

OH-Functional Inventive Dispersions:

### Example 17

### 30% Walsroder® Nitrocellulose E560/IPA 30

233.8 g of a difunctional polyesterpolyol as per Example were heated to 65° C. Subsequently at 65° C. 41.3 g of hexamethylene diisocyanate were added over the course of 5 minutes and the mixture was stirred at 100° C. until the theoretical NCO value of 3.3% was reached. The finished prepolymer was dissolved with 322.9 g of acetone at 50° C. and subsequently a solution of 20.2 g of diaminosulphonate, 4.1 g of N-(2-hydroxyethyl)ethylenediamine and 77.3 g of water was metered in over the course of 5 minutes. The subsequent stirring time was 15 minutes. Subsequently over the course, of 5 minutes a solution of 176.5 g of Walsroder® Nitrocellulose E560/IPA 30% and 700.2 g of acetone was added. Dispersion took place by addition of 529.4 g of water over the course of 10 minutes. In a subsequent distillation step the solvents were removed under reduced pressure to give a storage-stable PU dispersion having a solids content of 40.0%, a particle size of 313 nm and an OH content of 0.16% by weight with respect to resin solids.

### Example 18

### 30% Walsroder® Nitrocellulose E560/IPA 30%

233.8 g of a difunctional polyesterpolyol as per Example 1 were heated to 65° C. Subsequently at 65° C. 41.3 g of hexamethylene diisocyanate were added over the course of 5 minutes and the mixture was stirred at 100° C. until the theoretical NCO value of 3.3% was reached. The finished prepolymer was dissolved with 322.9 g of acetone at 50° C. and subsequently a solution of 20.2 g of diaminosulphonate, 5.9 g of N,N′-bis(2-hydroxyethyl)ethylenediamine and 77.3 g of water was metered in over the course of 5 minutes. The subsequent stirring time was 15 minutes. Subsequently over the course of 5 minutes a solution of 177.6 of Walsroder® Nitrocellulose E560/IPA 30% and 704.5 g of acetone was added. Dispersion took place by addition of 533.1 g of water over the course of 10 minutes. In a subsequent distillation step the solvents were removed under reduced pressure to give a storage-stable PU dispersion having a solids content of 41.8% and an average particle size of 289 nm and an OH content of 0.32% by weight with respect to resin solids.

Nonionically Stabilized Inventive Dispersion

### Example 19

### 10% Walsroder® Nitrocellulose E560/IPA 30%

264.4 g of Desmophen® C2200, 31.5 g of Polyether LB 25 and 6.3 g of neopentyl glycol were heated to 65° C. Subsequently at 65° C. 67.9 g of Desmodur® W and 11.3 g of isophorone diisocyanate were added over the course of 5 minutes and the mixture was stirred at 100° C. until the theoretical NCO value of 2.43% was reached. The finished prepolymer was dissolved with 434.9 g of acetone at 50° C. and subsequently a solution of 2.4 g of diethylenetriamine, 2.5 g of hydrazine hydrate and 15.3 g of water was metered in over the course of 10 minutes. The subsequent stirring time was 5 minutes. Subsequently over the course of 5 minutes a solution of 61.1 g of Walsroder® Nitrocellulose E560/IPA 30% and 242.5 g of acetone was added. Dispersion took place by addition of 625.6 g of water over the course of 15 minutes. In a subsequent distillation step the solvents were removed under reduced pressure to give a storage-stable PU dispersion having a solids content of 40.0% and an average particle size of 283 nm.

Other Inventive Dispersions:

### Example 20

### 30% Walsroder®. Nitrocellulose E560/IPA 30%

140.0 g of a difunctional polyesterpolyol based on adipic acid and hexanediol (average molecular weight 840 g/mol, OHN=106 mg KOH/g solids), 7.7 g of trimethylolpropane and 6.5 g of 1,6-hexanediol were heated to 65° C. Subsequently at 65° C. over the course of 5 minutes 99.6 g of Desmodur® W, 18.1 g of hexamethylene diisocyanate and 68.0 g of acetone were added and the mixture was stirred at reflux temperature until the theoretical NCO value of 4.46% was reached. The finished prepolymer was dissolved with 392.6 g of acetone at 50° C. and subsequently a solution of 4.6 g of hydrazine hydrate and 20.1 g of water was metered in over the course of 5 minutes. The subsequent stirring time was 5 minutes. Subsequently over the course of 10 minutes a solution of 28.4 g of diaminosulphonate and 78.0 g of water was added. Thereafter a solution of 176.1 g Walsroder® Nitrocellulose E560/IPA 30% and 698.5 g of acetone was added. Dispersion took place by addition of 500.9 g of water over the course of 10 minutes. In a subsequent distillation step the solvents were removed under reduced pressure to give a storage-stable PU dispersion having a solids content of 39.0% and an average particle size of 192 nm.

### Example 21

### 10% Walsroder® Nitrocellulose E560/IPA 30%

252.0 g of Desmophen® C2200, 10.1 g of Polyether LB 25, 3.2 g of neopentyl glycol and 8.8 g of dimethylolpropionic acid were heated to 65° C. Subsequently at 65° C. 76.3 g of Desmodur® W and 12.7 g of isophorone diisocyanate were added over the course of 5 minutes and the mixture was stirred at 100° C. until the theoretical NCO value of 2.81% was reached. The finished prepolymer was dissolved with 6.5 g of triethylamine and 434.9 g of acetone at 50° C. and subsequently a solution of 2.7 g of diethylenetriamine, 2.9 g of hydrazine hydrate and 17.2 g of water was metered in over the course of 10 minutes. The subsequent stirring time was 5 minutes. Subsequently over the course of 5 minutes a solution of 59.4 g of Walsroder® Nitrocellulose E560/IPA 30% and 235.7 g of acetone was added. Dispersion took place by addition of 606.6 g of water over the course of 15 minutes. In a subsequent distillation step the solvents were removed under reduced pressure to give a storage-stable PU dispersion having a solids content of 38.0% and an average particle size of 130 nm.

### Example 22

### 30% Walsroder® Nitrocellulose E560/IPA 30%

196.0 g of Desmophen® C2200, 7.9 g of Polyether LB 25, 2.5 g of neopentyl glycol and 8.2 g of dimethylolpropionic acid were heated to 65° C. Subsequently at 65° C. 60.7 g of Desmodur® W and 11.0 g of isophorone diisocyanate were added over the course of 5 minutes and the mixture was stirred at 100° C. until the theoretical NCO value of 2.76% was reached. The finished prepolymer was dissolved with 6.1 g of triethylamine and 450.9 g of acetone at 50° C. and subsequently a solution of 2.1 g of diethylenetriamine, 2.2 g of hydrazine hydrate and 13.4 g of water was metered in over the course of 10 minutes. The subsequent stirring time was 5 minutes. Subsequently over the course of 5 minutes a solution of 181.2 g of Walsroder® Nitrocellulose E560/IPA 30% and 718.8 g of acetone was added. Dispersion took place by addition of 620.1 g of water over the course of 15 minutes. In a subsequent distillation step the solvents were removed under reduced pressure to give a storage-stable PU dispersion having a solids content of 40.0% and an average particle size of 310 nm.

### Example 23

### 20% Walsroder® Nitrocellulose E560/IPA 30%

292.5 g of a difunctional polyesterpolyol based on adipic acid and 1,4-butanediol (average molecular weight 2250 g/mol, OHN=50 mg KOH/g solids) were heated to 65° C. Subsequently at 65° C., 19.7 g of 1,6-hexamethylene diisocyanate and 13.0 g of isophorone diisocyanate were added over the course of 5 minutes and the mixture was stirred at 80° C. until the theoretical NCO value of 1.18% was reached. The finished prepolymer was dissolved with 300.0 g of acetone at 50° C. and subsequently a solution of 1.7 g of diethanolamine, 8.5 g of diaminosulphonate and 51.0 g of water was metered in over the course of 10 minutes. The subsequent stirring time was 60 minutes. Subsequently over the course of 5 minutes a solution of 118.1 g of Walsroder® Nitrocellulose E560/IPA 30% and 468.4 g of acetone was added. Dispersion took place by addition of 564.3 g of water over the course of 15 minutes. In a subsequent distillation step the solvents were removed under reduced pressure to give a storage-stable PU dispersion having a solids content of 40.0% and an average particle size of 243 nm.

### Example 24

### 40% Walsroder® Nitrocellulose E 560/Water 30%

212.5 g of a difunctional polyesterpolyol based on adipic acid and hexanediol and neopentylglycol (average molecular weight 1700 g/mol, OHN=66 mg KOH/g solids) were heated to 65° C. Subsequently at 65° C. over the course of 5 minutes 37.6 g of hexamethylene diisocyanate were added and the mixture was stirred at 100° C. until the theoretical NCO value of 3.3% was reached. The finished prepolymer was dissolved with 375 g of acetone at 50° C. and subsequently a solution of 20.2 g of diaminosulphonate, 2.2 g of ethylenediamine and 90.0 g of water was metered in over the course of 5 minutes. The subsequent stirring time was 15 minutes. Subsequently over the course of 5 minutes a solution of 268.0 g of Walsroder® Nitrocellulose E 560/water 30% and 893.4 g of acetone was added. Dispersion took place by addition of 458.4 g of water over the course of 10 minutes. In a subsequent distillation step the solvents were removed under reduced pressure to give a storage-stable PU dispersion having a solids content of 41.0% and an average penticule size of 279 nm.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Aqueous dispersions comprising polyurethane-nitrocellulose particles having a particle size of 20 to 700 nm and having a polyurethane fraction comprising as its synthesis components compounds selected from the group consisting of
a) organic polyisocyanates,
b) polyols having number-average molar weights of 400 to 8000 g/mol and having an OH functionality of 1.5 to 6,
c) low molecular weight compounds of molar weight 62 to 400 g/mol which possess two or more hydroxyl and/or amino groups,
d) low molecular weight compounds which possess a hydroxyl or amino group,
e)isocyanate-reactive compounds which additionally carry ionically or potentially ionically hydrophilicizing groups, and
f)isocyanate-reactive, nonionically hydrophilicizing compounds
and also a fraction of water-insoluble nitrocellulose.

2. Aqueous dispersions according to claim 1, characterized in that the nitrocellulose has a nitrogen fraction of 10.7% to 12.6% by weight, based on nitrocellulose solids.

3. Aqueous dispersions according to claim 1, wherein the polyols b) are polyester polyols or hydroxyl-containing polycarbonates of molecular weight Mn from 400 to 6000 g/mol.

4. Aqueous dispersions according to claim 1, wherein the polyols b) are hexanediol-adipic esters, butanediol-adipic esters, hexanediol-neopentyl glycol-adipic esters and hexanediol-phthalic esters.

5. Aqueous dispersions according to claim 1, wherein the nitrocellulose is damped with 10% to 40% by weight of isopropanol (based on the total mass of the as-supplied form).

6. Aqueous dispersions according to claim 1, wherein the amount of nitrocellulose, based on total solids, is 0.5% to 85% by weight.

7. A process for preparing the aqueous dispersion according to claim 1, the process comprising the steps of:
i) preparing an isocyanate-functional prepolymer from the synthesis components selected from the group consisting of compounds a)-f);
ii) chain extending or chain terminating the prepolymer with an amine-functional component;
iii) dispersing the prepolymer in water;
iv) adding nitrocellulose, and
iv) optionally, removing any remaining solvent by distillation,
wherein the step of chain extension/chain termination (ii) can occur before or after the dispersing step (iii),
and the step of adding nitrocellulose can occur before or after the dispersing step (iii), and before or after the chain extension/chain termination step (ii).

8. The process according to claim 6, wherein the nitrocellulose is dissolved in a keto-functional solvent prior to the step of adding the nitrocellulose to the isocyanate-functional prepolymer.

9. The process according to claim 7, wherein the keto-functional solvent is acetone.

10. The process according to claim 6, wherein the nitrocellulose is added after preparing the prepolymer (i) or after the chain extending/chain termination step (ii) and prior to the dispersing step (iii).

11. The process according to claim 6, wherein the chain extending/chain terminating step is carried out prior to the dispersing step.

12. The process according to claim 6, wherein the ratio of isocyanate groups to isocyanate-reactive groups is 1.05 to 3.5.

13. The process according to claim 6, wherein the isocyanate-functional prepolymer is prepared in a solvent which is of infinite miscibility in water, has a boiling point under atmospheric pressure of 40-100 C, and is substantially unreactive with the synthesis components.

14. Coating materials comprising aqueous dispersions according to claim 1.

15. A substrate coated with an aqueous dispersion according to claim 1.

16. A sizing composition, adhesive system or printing ink comprising an aqueous dispersion according to claim 1.

17. A cosmetic comprising an aqueous dispersion according to claim 1.

18. One or more layers of a substrate coated, adhesively bonded or bound with an aqueous dispersion according to claim 1.
